(19) United States
(12) Patent Application Publication
(10) Pub. No.: US 2019/0152180 A1
(43) Pub. Date: May 23, 2019

(54) Hydraulic Pelletizer

(71) Applicant: Donovan Mills, Ponca City, OK (US)

(72) Inventor: Donovan Mills, Ponca City, OK (US)

(21) Appl. No.: 15/816,355

(22) Filed: Nov. 17, 2017

(51) Int. Cl. B30B 15/00; B30B 11/20

(52) U.S. Cl. CPC B30B 15/0052; B30B 11/202; B30B 11/208; B30B 11/207

(57) ABSTRACT

A hydraulic pelletizer for pelletizing a material comprising at least one pelleting chamber consisting of at least one feed cone receiving a material, at least one die, at least one roller pressingly engaging the die, a die engagement interface, and at least one feed deflector forcing the material between the roller and the die, at least one hydraulic drive system having at least one hydraulic motor, at least one hydraulic pump, a hydraulic motor interface rotationally driving the die engagement interface, and a fluid tank; and a system controller, whereby the material enters the pelleting chamber where the hydraulic drive system powers the pelleting chamber components forming the material into a predetermined shape form in the die and upon reaching a desired size ejecting the pellets from the die.

### CROSS-REFERENCE TO RELATED APPLICATIONS

None.

### FIELD OF THE INVENTION

The invention generally relates to pelletizing materials such as animal feed, wood, and fuel by compressing the materials utilizing a pelletizer. In particular, the invention relates to a hydraulically driven pellet mill for pelletizing materials (hereinafter “pelletizer”) where the hydraulically driven pelletizer may comprise a pelletizer with a conditioning chamber and a pelleting chamber driven directly by a hydraulic motor with a hydraulic pump and controller that may be remotely situated relative to the pelletizer and direct drive motor allowing application of constant torque to the pelleting die, thus providing a more consistent pellet product.

### BACKGROUND

The current method of driving a pelletizer includes an indirect drive system utilizing large electric motors, belts, gears, and pulleys. The electric motor transfers its energy through a belt/chain to the pelletizer thus rotating the pelleting die to produce pellets. The belts/chains have some elasticity such that if the pelleting die binds, this binding is reflected in the stretching of the belt/chain. Additionally, this binding adds stress to the pulleys and belts requiring constant maintenance and causing failures. The current methods do not provide constant torque to the pelletizer thus creating some variability of the pellets. This method described for indirectly driving a pelletizer has significant disadvantages that are labor intensive, costly, and does not produce a consistent product.

### SUMMARY OF THE INVENTION

The present invention overcomes these shortcomings by providing a hydraulically-driven pelletizer with a hydraulic motor that is directly connected to the pelleting die and rollers of the pelletizer thus eliminating the belts, gears, and pulleys of the indirect drive system and providing constant torque to the pelletizer producing a more consistent pellet. The hydraulic pelletizer may consist of a conditioning chamber, a pelleting chamber, a hydraulic drive system, and a system controller.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent to those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### DESCRIPTION OF THE DRAWINGS

FIG. 1 is a perspective view of a hydraulic drive powering two pelletizers.

FIG. 2 is a rotated perspective view of a single hydraulic drive pelletizer

FIG. 3 is a side view of the single hydraulically driven pelletizer.

FIG. 4 is a perspective view of a conditioning chamber.

FIG. 5 is an exploded view of a conditioning chamber.

FIG. 6 is a perspective view of a pelleting chamber with a hydraulic motor.

FIG. 7 is a cross-sectional view of a pelleting chamber with a hydraulic motor.

FIG. 8 is an exploded view of a pelleting chamber with a hydraulic motor.

### DETAILED DESCRIPTION OF THE INVENTION

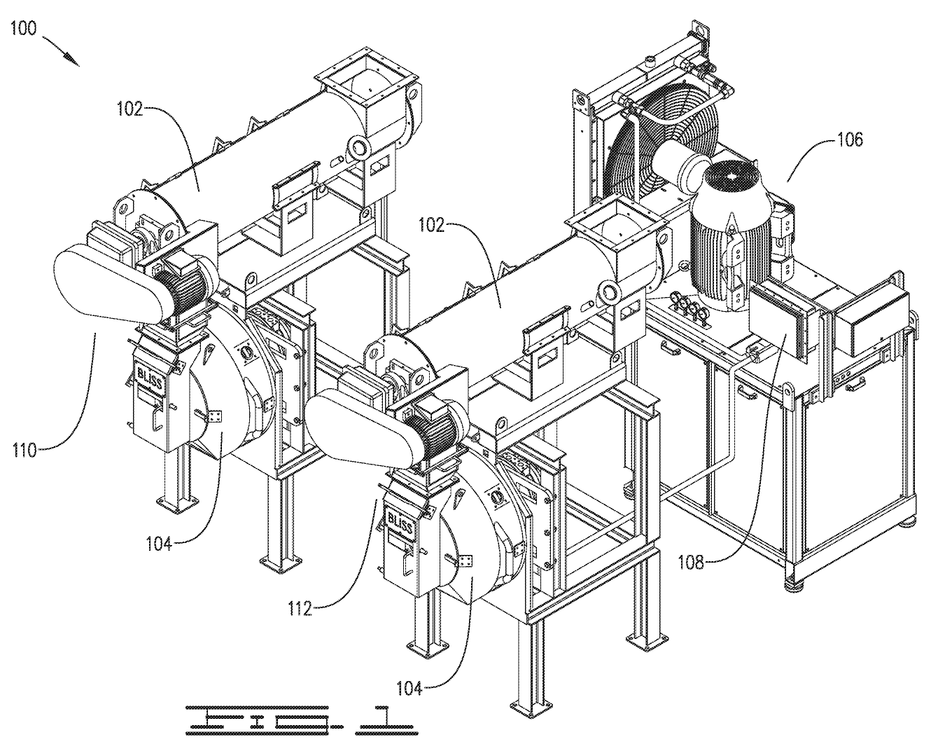

FIG. 1 is a perspective view 100 of a dual hydraulic pelletizer. A hydraulic pelletizer 110, 112 may comprise a conditioning chamber 102, a pelleting chamber 104, a hydraulic drive system 106, gages 210, and a system controller 108. In this view, the hydraulic drive system 106 powers and controls two pelletizers 110, 112. Each of the pelletizers 110, 112 may pelletizes different materials under a single operation of the hydraulic drive system 106. The hydraulic drive system 106 may power and control multiple pelletizers 110, 112 and may only be limited to the number of pelletizers controlled by the size and capacity of the hydraulic drive system 106 and system controller 108. In an alternative embodiment, the most basic configuration of a hydraulic pelletizer 110 may comprise a hydraulic drive system 106, a single pelleting chamber 104, and a system controller 108. The system controller 108 in this basic configuration may be selected from hydraulic control valves 212 and a motor speed control for a variable speed hydraulic pump 206, both of which may control the amount and pressure of hydraulic fluid that flows to the hydraulic motor 308 and rotating the pelleting chamber 104. A conditioning chamber 102 may be added to the basic hydraulic pelletizer configuration to condition the pelleting material before entering the pelleting chamber 104. The pelletization speed may be controlled both manually and automatically through the system controller 108. Additionally, the pelletization speed may be determined by control factors selected from material type, moisture, pellet density, and additives.

The system controller 108 may control the hydraulic pelletizer 110 electro-mechanically and mechanically. Additionally, the system controller 108 may be geographically separated from the hydraulic drive system 106 and pelletizer 110 and provide control inputs to the hydraulic drive system 106 and pelletizer 110 remotely. The hydraulic drive system 106 and pelletizer 110 may also be geographically separated. The separation of the system controller 108 promotes the health and safety of the operators by reducing noise exposure. An electronic system controller 108 may control the hydraulic pelletizer 110 through wired and wireless control inputs.

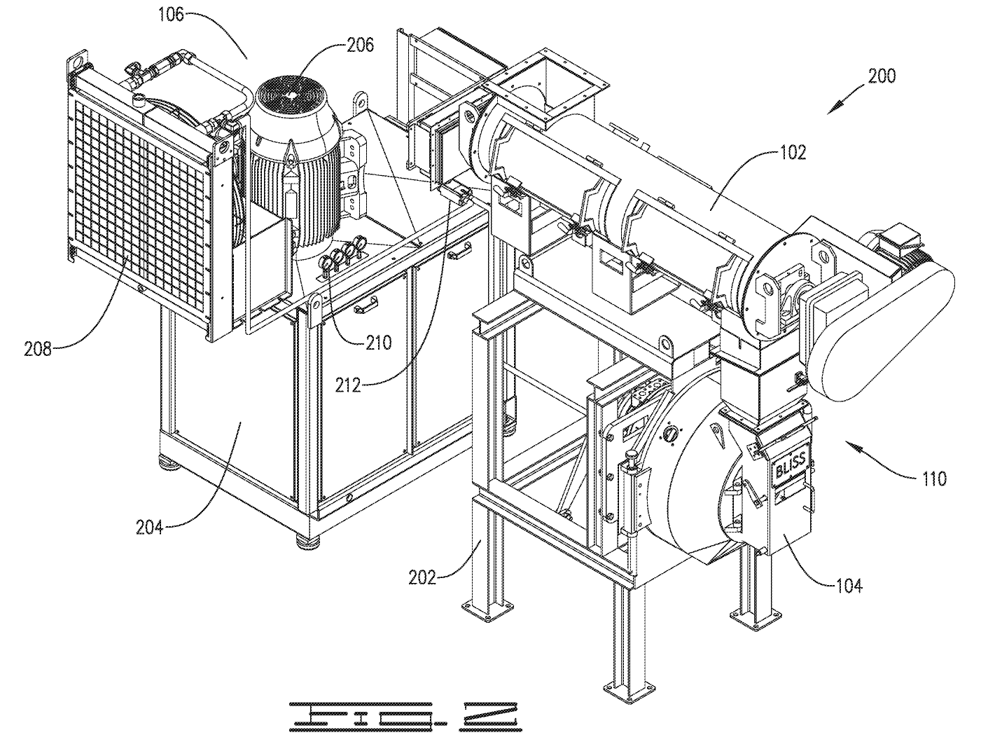

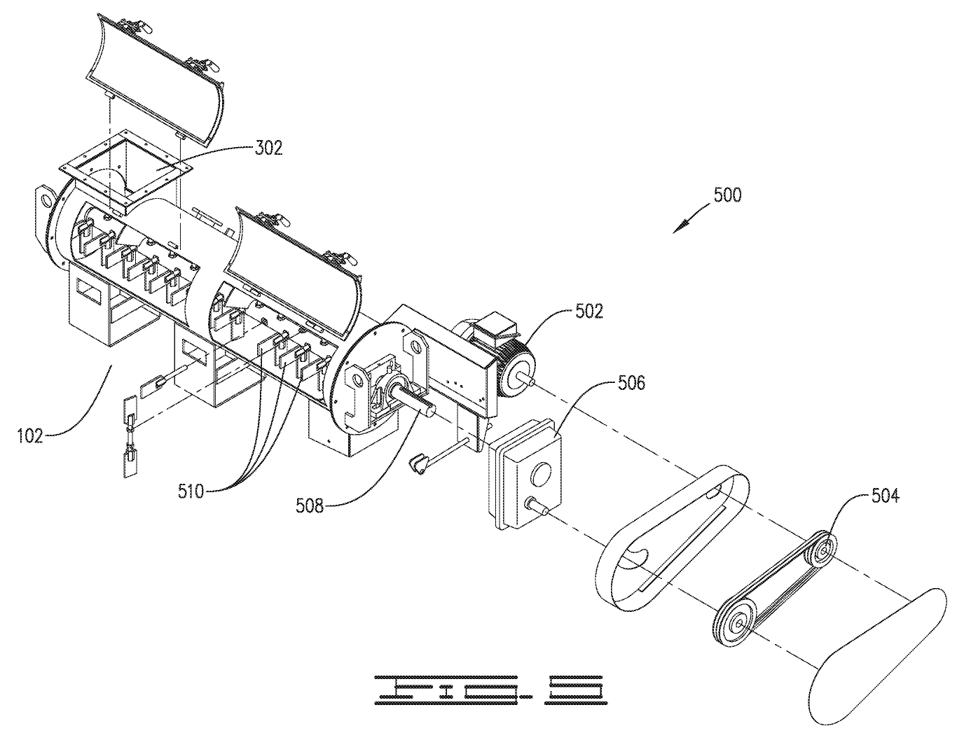

FIG. 2 is a rotated perspective view 200 of a single hydraulic drive pelletizer 110. As described above, the pelletizer 110 may consist of a conditioning chamber 102 that sits atop the pelleting chamber 104 wherein both the conditioning chamber 102 and the pelleting chamber 104 are affixed to a pelleting chamber stand 202. The hydraulic drive system 106 may comprise a hydraulic drive stand 204 that may contain an internal fluid tank 316 (not shown) for storing the hydraulic fluid, a hydraulic pump 206, a radiator 208, gages 210 and control valves 212 and a hydraulic motor 308 (not shown). The conditioning chamber 102 and pelleting chamber 104 are described in greater detail in FIGS. 5-8.

The hydraulic motor 308 provides the pelletizer 110 with power to create the pellets from the pelleting material. The hydraulic pump 206 drives the hydraulic motor 308 attached to the pelleting chamber 104 by forcing fluid from the internal fluid tank 316 to flow from the hydraulic pump 206 to the hydraulic motor 308 forcing the hydraulic motor 308 to rotate the pelleting chamber 104 and produce pellets. The hydraulic fluid then returns through the radiator 208 where the heated hydraulic fluid releases the absorbed heat and flows back into the internal fluid tank 316 in the hydraulic drive stand 204. This fluid flow process is constantly repeated to maintain the speed of the pelletizer 110. The gages 210 allow an operator to monitor the pressure, temperature, speed, torque, volume, and other desired parameters that would be apparent to one skilled in the art. The control valve 212 controls the speed or pressure at which the hydraulic fluid flows to the hydraulic motor 308 thereby providing constant torque during the pelleting process for a more uniform pellet.

The hydraulic pelletizer 110 accepts pelleting material placed in the conditioning chamber 102 where the conditioning chamber 102 conditions the pelleting material before entering the pelleting chamber 104 as it flows through the conditioning chamber 102 that is driven by an electric motor 502. In an alternate embodiment the condition chamber may be driven by a hydraulic motor. The conditioning chamber 102 transfers the conditioned pelleting mixture to the pelleting chamber 104 to be pelletized through a transfer chute 304. In an alternate nonpreferred embodiment, the hydraulic pelletizer 110 has no conditioning chamber 102 affixed and the pelleting material is supplied directly to the pelleting chamber 104 for pelletization through feeding and metering devices known to one skilled in the art.

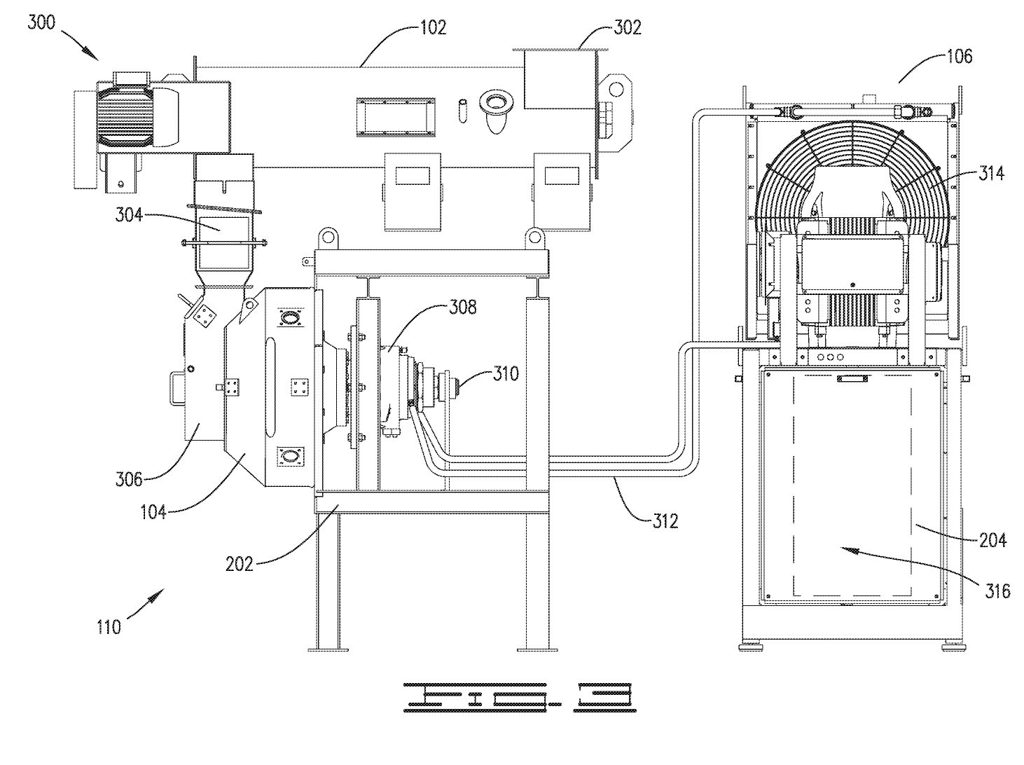

FIG. 3 is a side view 300 of the hydraulically driven pelletizer 110. In this preferred embodiment, the conditioning chamber 102 has a conditioning chamber material chute 302 where the material to be pelletized is inserted into the conditioning chamber 102. The pelleting material is then transported from the conditioning chamber material chute 302 to the opposite end of the conditioning chamber 102 where the conditioned material is then transferred through a transfer chute 304 into the bypass chute 306 which then enters into the pelleting chamber 104. The pelleting chamber 104 is affixed to the pelleting chamber stand 202 by a mounting plate 608 (not shown) and a main shaft holder 310 that supports and maintains the main shaft 704 alignment for the hydraulic motor 308 to freely rotate the hydraulic pelletizer 110.

The hydraulic pump 206 is in fluid communication with the hydraulic motor 308 by hydraulic hoses 312 that supply hydraulic fluid to the hydraulic motor 308 to drive the hydraulic motor 308 and rotate the pelleting chamber 104 then return the hydraulic fluid back to the fluid tank 316 in the hydraulic drive stand 204. As described above, the hydraulic drive system 106 may utilize a fan 314 to dissipate the heat of the hydraulic fluid as it flows from the hydraulic motor 308 to the fluid tank 316 thereby possibly increasing the longevity of the system.

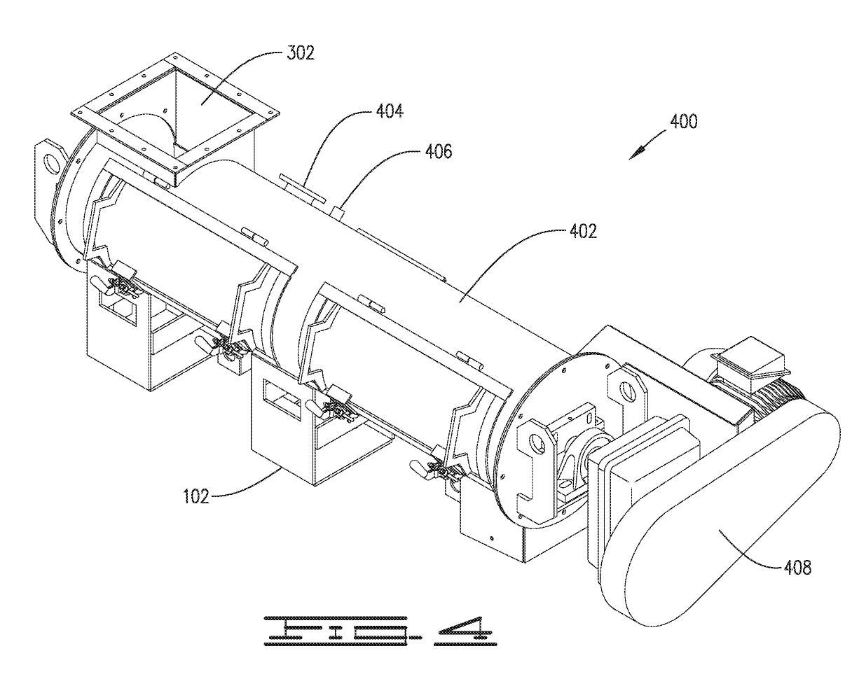

FIG. 4 is a perspective view 400 of the conditioning chamber 102. The conditioning chamber 102 may comprise a cylinder 402, conditioning chamber material chute 302, an additive input 404, a moisture input 406, and a conditioning chamber drive 408. The pelleting material enters the conditioning chamber 102 through the conditioning chamber material chute 302. Once the pelleting material is inside the conditioning chamber 102, the material may be moved to the opposite end of the conditioning chamber 102 by a conditioning chamber drive 408 that uses a paddle shaft 508 with a plurality of paddles to move and mix the material from the material chute 302 to the transfer chute 304 that will be described in greater detail in FIG. 5. As the pelleting material moves through the conditioning chamber 102 it may receive different types of additives with differing purposes and moisture. In the preferred embodiment the additive is delivered to the pelleting material utilizing a additive input 104. The additive input 404 may be selected from a chute, spout, a channel, and an orifice to deliver the additive to the pelleting material.

One type of additive may be a binding agent to help with the formation of the animal food pellets. Additionally, other additives to the animal food pelleting material could include medicinal additives for disease prevention, curing current ailments, and periodic animal maintenance such as tick prevention. Further, the additive could be dietary in nature such as adding vitamins, minerals, and protein supplements. For non-animal based pelleting material such as wood pellets and other biomass materials used for burning, one skilled in the art may use a binder for the creation of the pellets. Other additives may increase the speed at which the pellets ignite and burn and the additives may increase the burn time of the pellets. It would be apparent to one skilled in the art the possible additives that may be used in the preparation of the pelleting material for a desired purpose and effect. The conditioning chamber 102 is shown with only one additive input 404 but the conditioning chamber 102 may have multiple additive inputs 404. A system controller 108 may control the amount and the timing of the additive inputs 404 to the pelleting material.

As the pelleting material moves through the conditioning chamber 102, the pelleting material may also receive moisture from the moisture input 406. This moisture may be in a liquid or gaseous state. One skilled in the art would understand the type of moisture needed may be based on the type of pellet and any additional additives. In a preferred embodiment, multiple moisture inputs 406 are positioned above the pelleting material and along the length of the conditioning cylinder 402 to provide steam to the pelleting material as it travels through the conditioning chamber 102. The steam and heat may increase the binding potential of the pelleting material, thereby making the pelletizing process easier and more efficient. The moisture input 406 may be selected from a liquid sprayer and steam injection. A system controller 108 may control the amount, the timing, and the temperature of the moisture inputs 406 to the pelleting material.

FIG. 5 is an exploded view 500 of the conditioning chamber 102. The pelleting material may be moved from the conditioning chamber material chute 302 to the transfer chute 304 at the opposite end of the conditioning chamber 102 utilizing a conditioning chamber drive 408, a paddle shaft 508 and adjustable paddles 510. The conditioning chamber drive 408 may comprise an electric motor 502, a conditioner power transfer system 504, and a conditioner drive interface 506. An electric motor 502 provides power to the conditioner power transfer system 504, which then transfers the power to conditioner drive interface 506 affixed to the paddle shaft 508. The conditioner power transfer system 504 may be selected from a gear box, belt drive, and a chain drive. In the preferred embodiment, a belt drive consisting of a belt and pulleys may be used to transfer power from the electric motor 502 to the conditioner drive interface 506. The belt drive allows for slippage of the belt in the event the that there is a malfunction inside the conditioning chamber 102 that prevent the paddle shaft 508 from rotating without damaging the adjustable paddles 510. The electric motor 502 drives the conditioner power transfer system 504 which transfers the energy from the electric motor 502 to the paddle shaft 508 through a conditioner drive interface 506 where the conditioner drive interface 506 may change the torque applied to the paddle shaft 508 thereby adjusting the speed at which the pelleting material moves through the conditioning chamber 102. The conditioner drive interface 506 may be selected from a gear box, belt drive, and a chain drive capable of changing the ratio of input torque applied

Along the paddle shaft 508 may be a plurality of adjustable paddles 510 that integrates additives from the additive input 404 and moisture from the moisture input 406. The adjustable paddles 510 angles may be set to dictate the speed at which the pelleting material passes through the conditioning chamber 102. The adjustable paddles 510 may be adjusted individually or as group. Additionally, the conditioning chamber 102 may contain several groups of adjustable paddles 510 where each group may have a different angle with differing speeds. This group configuration may be preferable when the additives and moisture need more time to fully integrate them into pelleting material. Preferably, the adjustable paddles 510 are positioned before the production of the pellets but the conditioning chamber 102 may allow access to the adjustable paddles 510 so they may be adjusted at any time during the pelleting process. In an alternate embodiment, the adjustable paddle 510 angles may be automatically changed by an external control such as a system controller 108. The combination of the conditioning chamber drive 408 and the paddle shaft 508 and adjustable paddles 510 may control the speed at which the pelleting material transitions the conditioning chamber 102.

The pelleting material is inserted into the conditioning chamber material chute 302 where the conditioning chamber drive 408 rotates the paddle shaft 508 with the affixed adjustable paddles 510. The adjustable paddles 510 propels the pelleting material down through the conditioning chamber 102 where additives and moisture may be added to the pelleting material through the additive input 404 and the moisture input 406. As the additives and moisture are added the adjustable paddles 510 mix the moisture and the additives into the pelleting material as it moves through the conditioning chamber 102 where then the mixture exits the conditioning chamber 102 through the transfer chute 304.

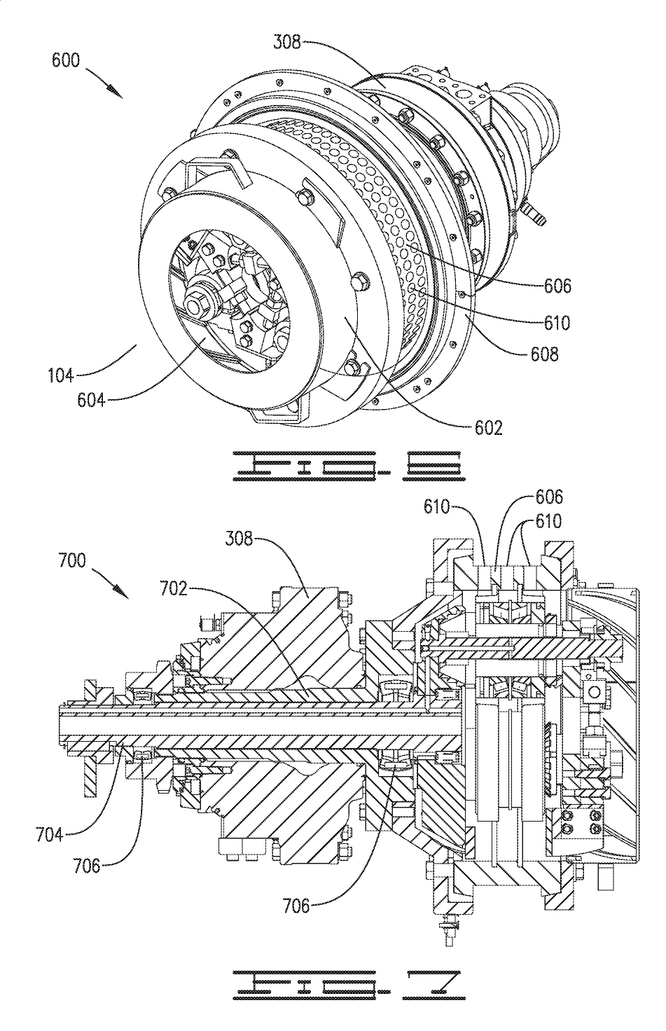

FIG. 6 is a perspective view 600 of a hydraulically driven pelleting chamber 104. The hydraulically driven pelleting chamber 104 may comprise of a feed cone 602, a feed cone input 604, a ring die 606 with ring die slots 610, a mounting plate 608, and a hydraulic motor 308. The mounting plate 608 may allow affixation of the hydraulically driven pelleting chamber 104 to the pelleting chamber stand 202 using fasteners, including but not limited to, bolts, screws, and fasteners with sufficient strength to absorb the torqueing stresses caused by the action of the hydraulic motor 308. The hydraulic motor 308 drives the pelleting chamber 104 rotationally where the conditioned pelleting mixture flows from conditioning chamber 102 into the feed cone 602 through a feed cone input 604 into the rollers 804. The conditioned pelleting mixture is then forced into the ring die 606 with preferably multiple ring die slots 610 by the rollers 804. The ring die slots 610 are radial drilled holes in the ring die 606 that allow the conditioned pelleting material to enter on the roller 804 side. In an alternative embodiment, the user may use dies with different die slot configurations including but not limited to configurations maximizing the number of pellets produced, mixed pellet sizing, and increasing pellet length. As the conditioned pelletized material accumulates inside the multiple ring die slots 610 it is condensed to a desired consistency to produce a pellet, which is then forced out of the ring die slots 610 on the exterior side of the ring die 606 and cut to a desired length. This process is furthered described in detail below.

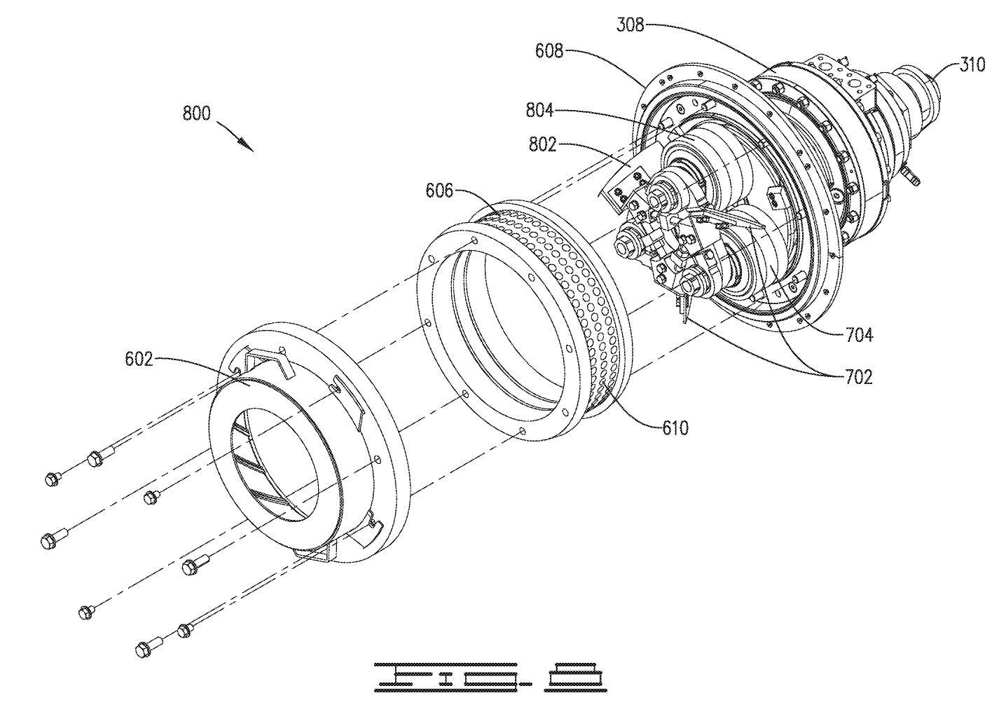

FIG. 7 is a cross-sectional view 700 of the hydraulically driven pelleting chamber 104. The hydraulic motor 308 rotates the pelleting chamber 104 through a die engagement interface 702. In the preferred embodiment, the hydraulic motor 308 directly engages the pelleting chamber 104 via a die engagement interface 702 using a tapered shaft with the main shaft 704 extending from the pelleting chamber 104 through the main shaft holder 310. Positioned fore and aft of the hydraulic motor 308 are bearings 706 allowing ring die 606 to rotate freely. The die engagement interface 702 may be selected from a flange mount, a tapered shaft, a compression fit, a clutch, a torque converter, a flexible coupling, a solid coupling, a splined shaft, and a keyed shaft to engage the hydraulic motor 308.

FIG. 8 is an exploded view 800 of the pelleting chamber 104. In the exploded view 800, the feed cone 602 is separated from the ring die 606 exposing the feed deflectors 802, and the rollers 804. The conditioned pelleting material flows down through a transfer chute 304 connected to the conditioning chamber 102 through a bypass chute 306. The pelleting mixture from the bypass chute 306 enters the feed cone 602 through the feed cone input 604. The bypass chute 306 allows for the conditioned pelleting mixture to bypass the feed cone 604 if the pelleting chamber 104 has a failure or becomes clogged.

As the ring die 606 rotates, the rollers 804 and the feed deflectors 802 within the pelleting chamber force the conditioned pelleting mixture into the spaces between the rollers 804 and the ring die 606 through the rotation moves the conditioned pelleting mixture from the spaces in between the rollers 804 into the ring die slots 610. The conditioned pelleting material keeps accumulating and compressing inside the ring die slots 610 to create a pellet. As more material is pressed from the roller 804 side of the ring die 606, a pellet exits the opposing side of the ring die 606 from the ring die slots 610 where the pellet may be cut or broke to a desired length.

Having thus described the invention, I claim:

1. A hydraulic pelletizer for pelletizing a material comprising:
a. at least one pelleting chamber consisting of—
i. at least one feed cone receiving a material,
ii. at least one die,
iii. at least one roller pressingly engaging the die,
iv. a die engagement interface, and
v. at least one feed deflector forcing the material between the roller and the die;
b. at least one hydraulic drive system having—
i. at least one hydraulic motor,
ii. at least one hydraulic pump,
iii. a hydraulic motor interface rotationally driving the die engagement interface, and
iv. a fluid tank; and
c. a system controller,
whereby the material enters the pelleting chamber where the hydraulic drive system powers the pelleting chamber components forming the material into a predetermined shape form in the die and upon reaching a desired size ejecting the pellets from the die.

2. The hydraulic pelletizer of claim 1, where the die engagement interface is selected from a flange mount, a tapered shaft, a compression fit, a clutch, a torque convertor, a flexible coupling, a solid coupling, a splined shaft, a shaft and key.

3. The hydraulic pelletizer of claim 1, where a speed of the hydraulic motor is manipulated by a system controller selected from a variable speed pump and control valve.

4. The hydraulic pelletizer of claim 3, where the pelletization speed is manually and automatically controlled.

5. The hydraulic pelletizer of claim 1, where the system controller is physically or geographically separated from the hydraulic pelletizer.

6. The hydraulic pelletizer of claim 5, where the system controller is selected from wired and wireless.

7. The hydraulic pelletizer of claim 1, where the hydraulic pump and tank are physically or geographically separated from the hydraulic pelletizer.

8. The hydraulic pelletizer of claim 1, where a conditioning chamber preconditions pelleting material before entering the pelleting chamber.

9. The hydraulic pelletizer of claim 1, where hydraulic drive system powers multiple conditioning and pelleting chambers.

10. A hydraulic pelletizer for pelletizing a material comprising:
a. a material to be pelletized;
b. at least one pelleting chamber consisting of—
i. at least one die fixedly attached to a shaft adapted to rotate and accept the material into a predetermined shape form in the die and form the mixture into pellets where upon reaching the desired size are ejected from the die,
ii. at least one roller pressingly engaging the die,
iii. a shaft rotationally engaging a hydraulic drive motor to rotate the die in the pelleting chamber,
iv. at least one feed cone accepting the mixture, and
v. at least one feed deflector forcing the material between the roller and die;
c. a hydraulic drive system having—
i. a hydraulic motor,
ii. a hydraulic pump,
iii. a splined shaft, and
iv. a fluid tank; and
d. a system controller,
whereby the material to be pelletized is transferred to the pelleting chamber where the hydraulic drive system powers the pelleting chamber components through the shaft, where the die rotates receiving material and creating pellets.

11. A hydraulic pelletizer for pelletizing a material comprising:
a. at least one conditioning chamber with an entrance at which the material enters and an exit from which a mixture exits having—
i. at least one pelletizing material chute adjacent to the entrance,
ii. at least one paddle shaft with a plurality of paddles thereon, and
iii. a drive interface for receiving rotational input from a motor, changing its rotational rate, and transferring the rotational rate to the paddle shaft;
b. at least one pelleting chamber consisting of—
i. at least one feed cone receiving the mixture from the conditioning chamber exit into the pelleting chamber,
ii. at least one die,
iii. at least one roller pressingly engaging the die,
iv. a die engagement interface for rotationally coupling a hydraulic drive motor to rotate the die and rollers relative to one another, and
v. at least one feed deflector forcing the mixture between the roller and the die;
c. at least one hydraulic drive system having—
i. at least one hydraulic drive motor,
ii. at least one hydraulic pump,
iii. a hydraulic motor interface, and
iv. a fluid tank; and
d. a system controller,
whereby the mixture is prepared in the conditioning chamber then transferred to the pelleting chamber where the hydraulic drive system powers the pelleting chamber components forming the mixture into a predetermined shape form in the die and upon reaching a desired size ejecting the pellets from the die.

12. The hydraulic pelletizer of claim 11, where the conditioner has at least one additive input.

13. The hydraulic pelletizer of claim 11, where the additive input is selected from a chute, a spout, a channel, and an orifice.

14. The hydraulic pelletizer of claim 11, where the conditioner has at least one moisture input for infusing a desired level of moisture into the mixture.

15. The hydraulic pelletizer of claim 11, where the moisture input is selected from a sprayer and steam injection.

16. The hydraulic pelletizer of claim 11, where the drive interface is selected from a gear box, belt drive, and a chain drive.

17. The hydraulic pelletizer of claim 11, where the paddle angles are variable, whereby the rate of travel of the mixture can be changed.

18. The hydraulic pelletizer of claim 17, where the paddle angles may be manually or automatically changed.

19. The hydraulic pelletizer of claim 11, where the die engagement interface is selected from a flange mount, a tapered shaft, a compression fit, a clutch, a torque convertor, a flexible coupling, a solid coupling, a splined shaft, a shaft and key.

20. The hydraulic pelletizer of claim 11, where the speed of the hydraulic motor is manipulated by a control system selected from a variable speed pump and control valves.

21. The hydraulic pelletizer of claim 11, where the pelletization speed is determined by control factors, the control factors selected from a group comprising material type, moisture, pellet density, and additives.

22. The hydraulic pelletizer of claim 21, where the pelletization speed is manually and automatically controlled.

23. The hydraulic pelletizer of claim 11, where the system controller is separated from the hydraulic pelletizer.

24. The hydraulic pelletizer of claim 23, where the system controller is selected from wired and wireless.

25. The hydraulic pelletizer of claim 11, where the hydraulic pump and tank are separated from the hydraulic pelletizer.

26. The hydraulic pelletizer of claim 11, where hydraulic drive system powers multiple conditioning and pelletizing chambers.

27. The hydraulic pelletizer of claim 11, where the speed of the hydraulic motor is manipulated by a control system, the control system selected from a variable speed pump, a constant speed pump, and control valves.

28. A hydraulic pelletizer for pelletizing a material comprising:
a. a material to be pelletized
b. at least one conditioning chamber having—
i. at least one pelletizing material chute,
ii. at least one additive input for receiving and transferring additives into the material to create a mixture,
iii. at least one steam inlet for infusing a desired level moisture and heat into the mixture,
iv. at least one gearbox for receiving rotational input from motor, changing a rotational rate, and transferring the rotational rate to a paddle shaft,
v. at least one motor for rotationally engaging the gear box, and
vi. at least one paddle shaft with a plurality of paddles thereon mixing the material, additives, and moisture and moving the mixture through the conditioning chamber to an exit;
c. at least one pelleting chamber consisting of—
i. at least one die fixedly attached to a shaft adapted to rotate and accept the mixture into a predetermined shape form in the die and form the mixture into pellets where upon reaching the desired size are ejected from the die,
ii. at least one roller pressingly engaging the die,
iii. a shaft rotationally engaging a hydraulic drive motor to rotate the die in the pelleting chamber,
iv. at least one feed cone adapted to transfer the mixture from the conditioning chamber exit to the pelleting chamber,
v. at least one feed deflector forcing the material between the roller and die
d. a hydraulic drive system having—
i. a hydraulic drive motor,
ii. a hydraulic pump,
iii. a splined shaft, and
iv. a fluid tank; and
e. a system controller,
whereby the material to be pelletized is prepared in the conditioning chamber then transferred to the pelleting chamber where the hydraulic drive system powers the pelleting chamber components through the shaft, where the die rotates receiving material and creating pellets.
